(19) United States
(12) Patent Application Publication
(10) Pub. No.: US 2009/0315333 A1
(43) Pub. Date: Dec. 24, 2009

(54) PRODUCTION OF ELECTRICITY FROM LOW-TEMPERATURE ENERGY SOURCES

(76) Inventor: John Azar, Bujumbura (BI)

Correspondence Address: YOUNG & THOMPSON, 209 Madison Street, Suite 500, Alexandria, VA, 22314, US

(21) Appl. No.: 12/295,333

(22) PCT Filed: Nov. 6, 2006
(86) PCT No.: PCT/BE2006/000119

§ 371 Date: Mar. 26, 2009

(30) Foreign Application Priority Data
Mar. 31, 2006 (BE) 2006/0203

(51) Int. Cl. H02K 7/18

(52) U.S. Cl. 290/1 A

(57) ABSTRACT

The invention relates to a system for producing energy from a coolant (4) that comprises an electricity generator (13) combined with a turbine (2) that is supplied by an air flow (30) that is admitted into the base of a tower. The tower is equipped with various blade stages (40) that are made integral with a central shaft (2) that drives the generator, and, alternately, heat exchanger stages (10). Said blades are driven by the rise of heated air as it rises in the tower by thus creating an artificial vertical wind. The coolant (4) supplies the heat exchangers (10) by descending through the latter from the one that is located at the uppermost level.

This invention relates to an arrangement and a process for the exploitation of low-temperature energy sources with production of electricity by artificial wind and medium-speed turbines.

At present, safe energy sources that are used for the production of electricity are essentially those of wind, with use of large-diameter windmills.

The selection of large diameters is based on the fact that the energy that can be collected is based on the collecting surface, in other words the square of the diameter of the blades of the windmill.

This judicious choice has its limits, however, because the increase in the inertia of the system with the increase of the diameter (and that of the number of blades) causes the recovery of energy from low wind speeds to be lost (the minimum speed from which the windmill can produce current increases).

This energy, however, is also based on the cube of the speed of the wind, but man controls neither the wind speed nor the direction thereof. The larger the diameter, the higher the windmill will become. The flexion moment at the fitting (at the base) of the support pylon will become significant and will make it necessary to “feather” the windmills for lower speeds, which greatly reduces the “window” of usable winds.

There are currently quite a large number of publications relative to the use of a phenomenon that has been known for a long time, which is that of the rise of hot air. These publications describe devices that make it possible to pick up the energy of these artificial winds by using “windmills” or turbines inside a type of chimney with a draft effect, whose major benefit is to have a wind of constant direction.

By way of examples, it is possible to cite the documents of patents GB 2302139, DE 19831492 and DE 3636248.

The cost benefit of similar systems, however, has not allowed their applications to date. The situation could change based on the increase of the prices per petroleum barrel. The yield of the installations will then become a predominant factor.

This invention has as its object to propose an improved, more flexible system that allows more energy to be recovered by transforming the “windmill” system into a particular “turbine” system.

The windmills used nowadays are limited to wind speeds below 80 or 90 km/h, for the reasons explained above.

The “rated” speeds are generally on the order of 20 to 30 km/h.

The gas turbines operate when they have much higher gas speeds, generally subsonic on the order of 800 km/h (aircraft engines can exceed the speed of sound), and the outputs are significantly larger.

For its part, the system that is presented below is located at an intermediate speed level (on the order of 100 to three hundred km/h) and, according to a primary characteristic, uses several stages of fins (and not windmills) that significantly improve the output.

This invention therefore relates to such a system.

In general, the invention actually has as its object to propose a system that is designed for producing electricity by mechanical means from the recovery of calories conveyed inside a system of heat exchangers set at several stages, i.e., in a fractionated manner. The other characteristics are described in the accompanying claims.

Stages are interposed between these set heat exchanger stages, and said stages comprise fins or blades secured on a central, vertical and rotary shaft, a shaft that extends downward until becoming the shaft of an electricity generator located at the lower part.

According to one aspect of the invention, a more or less significant acceleration of speed can be obtained by providing an air intake section (at the base) that is significantly higher than the air discharge section (at the top).

One embodiment is described below, only by way of example, by referring to the accompanying drawings in which:

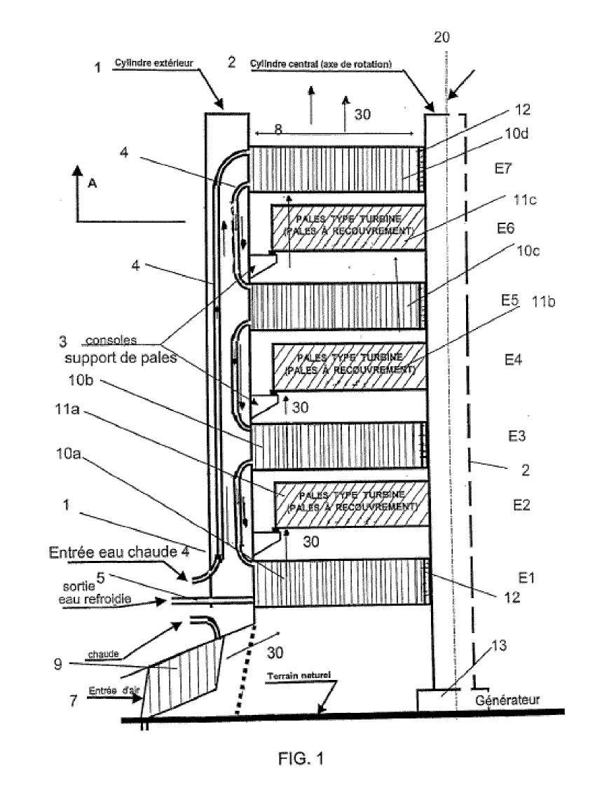

FIG. 1 shows a vertical half-section of an arrangement according to the invention.

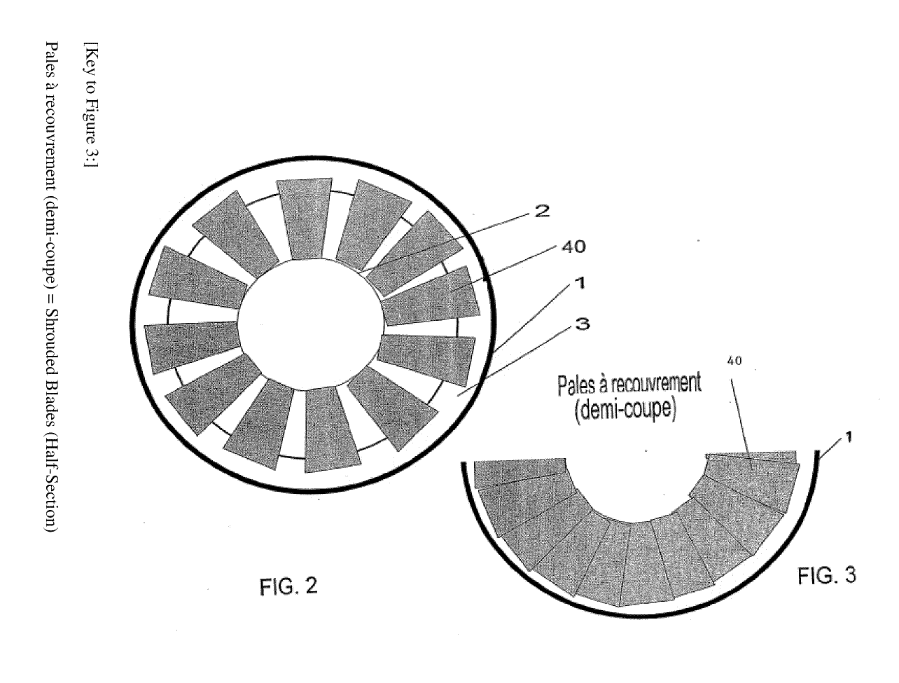

FIGS. 2 and 3 show a horizontal cutaway of a stage of blades (plane A of FIG. 1) presented in two embodiments: multiple blades and multiple shrouded blades. The selection is made based on dimensions of the installation and wind speeds reached.

The system is formed by a tower that consists of two concentric cylinders 1, 2 that have the same central vertical shaft 20.

A stream of artificial air 30, which is an upward stream of hot air, is obtained from the contact of the air with the stationary metal walls of heat exchangers 10 (systems with fins) that are located on several stages of the tower (for example, ground level and “odd stages”), placed between the outer cylinder 1 and the inner cylinder 2.

The heating level of the air 30 at ground level represents the first heating level 9 (in actuality a “preheating”) at the location where the annular section 7 of the air input is larger than the output 8, hence the appearance of an acceleration phenomenon. At this level, the air is preheated at 9 before passing through the exchanger 10a of the first stage E1 to be heated again before penetrating stage E2, the one of the first level of turbine blades.

The “even stages” are mobile and rotate around the vertical central shaft 20 of the tower, thus constituting the “turbine” part of the system. They consist of fins or blades 40 of turbines, welded onto the inner cylinder 2 of the system so as to be entrained by a rotary motion produced by the force of the hot air 30 that rises at speeds that can be much higher than those of rated speeds of windmills.

The exchangers 10 are secured directly onto the outer cylinder 1 and can be corbelled or mounted if necessary—in the cases of large dimensions—on the central shaft by means of a ball bearing support 12 or an equivalent arrangement (since the shaft will be made to rotate and the heat exchangers are stationary).

In contrast, the turbine fin-blades 40 are secured directly and, preferably only, on the inner cylinder 2, exactly like the fins of a turbine on their rotary support. FIG. 1 illustrates the case, however, where the ends of the blades rest on annular brackets 3.

The coolant 4, circulating in thermally insulated ducts, is brought to the uppermost exchanger 10d and from there, it goes down again to supply—successively and in order—the other exchangers 10c, 10b and 10a, starting from the uppermost to the lowest.

This circulation of the liquid 4 is done naturally, like the natural circulation of the hot water from the central heating of a building, but it can be “assisted” by one or more circulation pumps that will provide a constant rhythm to the motion.

In its descent, the coolant 4 loses its calories little by little, and said calories are transferred to the surrounding air.

The air that is drawn into the bottom of the system is at the temperature of the outside air and has the same degree of hygrometry.

Upon contact with the fins of the first exchanger (preheating) at ground level where the coolant, which has already lost a good portion of its temperature, circulates, the air is preheated. As a result, it expands, thus creating an overpressure that pushes this air upward through said preheating fins so as to pass through the heat exchanger of stage E1 and then the blades 40 of the turbine at stage E2.

As a result, there will be a transfer of energy by creation of a circular movement of the central cylinder 2, which is manifested as a relief of pressure and a temperature reduction of the air.

The air will then move to the odd stage E3, where it will come into contact with other heat exchangers where the coolant, which has a temperature that is more than that of stage E1, circulates. The cycle is thus started again: additional heating, new overpressure, passage through the fins of stage E4, additional rotary motion imparted to the shaft, relief of pressure, and lowering of the temperature of the air.

It will be thus until the very last turbine is reached, where, after having ceded a portion of its energy, the hot air will be evacuated into the atmosphere.

It is evident that this system allows a better use of air when it passes the first level of rotation (which “bypasses” the blockage described by Besse). In its principle, this system is similar to that of combined-cycle turbines that have a much larger overall output than the single turbines.

The sum of the stresses transmitted to the blades of the turbine will thus accumulate to impart to the central cylinder 2 (the rotor of the system) a rotary motion that, via the generator that is located on its pedestal at the base of the tower, will provide an electric current that is significant because it is based on the output speed (whereby the energy is based on the cube of this speed).

It will be noted that in its rotation, the generator 13 will release heat. Given the position of the generator in the tower, it is obvious that this heat will be transmitted to the ambient air, thus recovering an amount of energy that can be estimated at 2% for a particular case.

So as to be able to use this system permanently when it is necessary, it is possible to provide a storage means for the coolant, for example in thermally insulated tanks.

The heat of the coolant can be obtained from various sources, for example a geothermal source, solar sensors or the recovery of heat from an industrial process.

When, for example, solar energy is used for heating the coolant 4, the liquid can be heated during the day in a circuit that is separated from that of the daily operation and stored in one or more tanks so as to be used during the night (the outside air being cooler, this will consequently provide a better yield, which will at least partially compensate for the losses due to the cooling of the coolant during its storage).

When geothermal energy is used for heating the coolant, the heating and the storage will advantageously be done differently: the coolant consists of ordinary water that circulates in pipes with fins aligned with the bottom of the mine, pipes whose outside surface is protected from chemical attacks by, for example, a suitable paint.

Since it takes a certain amount of time to “pump” the calories from the mine to the coolant, it will be sufficient to provide several networks of pipes. If, for example, 16 hours are necessary to bring the coolant to the temperature of the bottom water of the mine (for example, 80° C.), it would then be sufficient to provide three networks of pipes (8 hours to “empty” the calories from a network and 16 hours to recover them at the bottom of the mine, whereby during these 16 hours, the two other networks take over). Thus, three networks allow a 24-hour operation.

Given the consistency of the rotational speed (adjustable by simple adjusting of the flow rate of the coolant), the electrical current that is obtained is synchronous, and, with simple (and existing) regulation, can be sent directly to the distribution circuit, either low-, medium- or high-voltage.

The invention therefore describes a system for transmission and fractionated recovery of the energy of a coolant that causes an artificial wind that is particularly flexible and effective. It will be understood that numerous variants can be provided to the device of the invention described below without exceeding the scope of the invention. It thus is possible to provide, in particular upon start-up, means for gradual engagement of different levels of blades relative to the rotor.

1. System for producing energy from a coolant (4) that comprises an electricity generator (13) combined with a turbine (2) supplied by an air flow (30) that is admitted into the base of a tower, characterized in that the tower is equipped with various blade stages (40), made integral with a central shaft (2) that drives the generator and, alternately, heat exchanger stages (10), whereby said blades are driven by the rise of heated air as it rises in the tower, whereby the coolant (4) supplies the heat exchangers (10) by descending through the latter from the one that is located at the uppermost level.

2. System according to claim 1, wherein the tower and the shaft are cylindrical and co-axial.

3. System according to claim 2, wherein the exchangers (10) are secured onto the outer cylinder (1) by corbelling.

4. System according to claim 3, wherein the inner ends of the exchangers rest on the central shaft by means of a ball bearing or an equivalent means.

5. System according to any of the preceding claims, wherein the blades are of the shrouded type.

6. System according to any of the preceding claims, wherein the input of air at the base of the tower comprises a preheating system, preferably by said coolant.

7. System according to any of the preceding claims, wherein it comprises between 3 and 10 stages of blade exchangers (40) located between exchanger stages (10).

8. System according to any of the preceding claims, wherein the air intake section (7) at the base of the tower is essentially larger than the air discharge section (8) at the top of the tower.

9. System according to any of the preceding claims, wherein it comprises a device for storing coolant.

10. System according to any of the preceding claims, wherein the heat from the coolant (4) is obtained from a solar sensor or a geothermal source.

11. System according to claim 10, wherein the heat source is geothermal and wherein three networks of pipes placed at the bottom of a mine, which optionally may or may not be used, are provided.

12. System according to any of the preceding claims, wherein the coolant is water.

13. System according to any of the preceding claims, wherein the electrical current that is produced is synchronous.
